(19) United States
(12) Patent Application Publication
(10) Pub. No.: US 2025/0292583 A1
(43) Pub. Date: Sep. 18, 2025

(54) System And Method For Pump Operation Panel Simulator Training

(71) Applicant: FAAC Incorporated, Ann Arbor, MI (US)

(72) Inventors: David Bouwkamp, Dexter, MI (US); Charles Scott Deakins, Norco, CA (US); Philip Duczyminski, Ypsilanti, MI (US); William B. Martin, Perrysburg, OH (US); Brian Post, Ypsilanti, MI (US); Jason Carl Raab, Ann Arbor, MI (US); Travis Staley, Milan, MI (US)

(21) Appl. No.: 19/079,109

(22) Filed: Mar. 13, 2025

Related U.S. Application Data
(60) Provisional application No. 63/565,171, filed on Mar. 14, 2024.

(51) Int. Cl. G06V 20/52; G06Q 10/0639; G06T 7/20; G06V 40/20

(52) U.S. Cl. CPC G06V 20/52; G06Q 10/06398; G06T 7/20; G06V 40/28

(57) ABSTRACT

A pump panel training device includes a plurality of gages operable to imitate gages upon a firetruck pump panel, a plurality of controls operable to imitate controls upon the firetruck pump panel, and a camera device capturing a plurality of images of a user operating the pump panel training device. The pump panel training device further includes a display device and one or more computerized processors which receive the plurality of images from the camera device and provide a training output to the user through the display device based upon the plurality of images.

### CROSS-REFERENCE TO RELATED APPLICATIONS

The subject patent application claims priority to, and all the benefits of, U.S. Provisional Patent Application No. 63/565,171, filed on Mar. 14, 2024, the entire contents of which are incorporated by reference herein.

### TECHNICAL FIELD

This disclosure is a training simulator, and, in particular, to a training simulator used to simulate operation of features of an emergency responder vehicle.

### BACKGROUND

The statements in this section merely provide background information related to the present disclosure. Accordingly, such statements are not intended to constitute an admission of prior art.

Fire department vehicles and other similar vehicles include complex systems that are installed or loaded onto the vehicle. In one exemplary embodiment, a fire pump truck includes incoming and outgoing water lines, for example, receiving a water flow from a fire hydrant, providing pressure to the water flow, and providing the pressurized water flow to fire fighters. Such pump trucks are complicated devices. Operating the pump machinery on the pump truck incorrectly may have adverse results. Too little pressure may result in fire fighters not being able to adequately fight fires and may result in increased injuries and property damage. Too much pressure may damage the pump machinery, damage hoses, and hamper firefighting efforts with unpredictable equipment behavior. A pump overheating may similarly cause damage and cause unpredictable equipment behavior.

Operation of a fire truck pump may be complicated, and time may be of the essence. Proper operation of the fire truck pump may require operations of a particular sequence.

### SUMMARY

A pump panel training device is provided. The pump panel training device includes a plurality of gages operable to imitate gages upon a firetruck pump panel, a plurality of controls operable to imitate controls upon the firetruck pump panel, and a camera device capturing a plurality of images of a user operating the pump panel training device. The pump panel training device further includes a display device and one or more computerized processors which receive the plurality of images from the camera device, and provide a training output to the user through the display device based upon the plurality of images.

In some embodiments, the one or more computerized processors may further provide the plurality of images to an instructor and receive an instructor review input of the user operating the pump panel training device. Providing the training output to the user includes providing the instructor review input to the user.

In some embodiments, the one or more computerized processors further monitors the user operating the pump panel training device. The monitoring includes monitoring user inputs to the plurality of controls, monitoring resulting outputs generated upon the plurality of gages, and scoring a performance of the user based upon the monitored user inputs or the monitored resulting outputs.

In some embodiments, the providing the training output includes combining the instructor review input to the user and the scored performance.

In some embodiments, the one or more computerized processors further automatically evaluates the user operating the pump panel training device based upon the plurality of images.

In some embodiments, automatically evaluating the user operating the pump panel training device includes initiating a simulation including identifying a set of spatial definitions defining a desired sequence of operations to be performed by a trainee during the simulation and operating the simulation upon the pump operation panel simulator including monitoring movements of the user through a camera device. Automatically evaluating the user may further include rendering the monitored movements of the user into spatial definitions defining performance of the user during the simulation and scoring the performance of the user based upon comparing the spatial definitions defining the performance of the user to the spatial definitions defining the desired sequence of operations. Automatically evaluating the user may further include generating an output based upon the scoring.

In some embodiments, evaluating the user operating the pump panel training device includes monitoring movements of the user through the camera device and scoring the performance of the user based upon comparing the monitored movements of the user to initial judgment criteria. Evaluating the user operating the pump panel training device may further include evaluating an outcome of the scoring and updating judgment criteria with an artificial intelligence subroutine and utilizing the updated judgment criteria during subsequent iterations of scoring the performance of the user.

In some embodiments, the computerized processor evaluating the user operating the pump panel training device includes the computerized processor tracking movement of at least one hand of the user.

In some embodiments, the pump panel training device further includes a marker device disposed and configured to provide a location of the at least one hand of the user to the computerized processor through the plurality of images.

In some embodiments, the computerized processor evaluating the user operating the pump panel training device includes scoring movement of a hand of the user in comparison to desired hand movement.

In some embodiments, the computerized processor evaluating the user operating the pump panel training device includes scoring the performance of the user in comparison to desired operation of the pump panel training device.

In some embodiments, the computerized processor evaluating the user operating the pump panel training device includes comparing movement of a hand of the user in comparison to recorded movement of an instructor operating the pump panel training device.

According to one alternative embodiment, a system comprising a plurality of pump panel training devices is provided. The system includes the plurality of pump panel training devices. At least one of the pump panel training devices includes a plurality of gages operable to imitate gages upon a fire truck pump panel and a plurality of controls operable to imitate controls upon the fire truck pump panel. The at least one pump panel training device further includes a camera device capturing a plurality of images of a user operating the pump panel training device and a display device. The system further includes at least one computerized processor operating to coordinate data between the plurality of pump panel training devices, receiving the plurality of images from the camera device, and providing a training output to the user through the display device based upon the plurality of images.

In some embodiments, the at least one computerized processor further provides the plurality of images to an instructor and receives an instructor review input of the user operating the pump panel training device. Providing the training output to the user includes providing the instructor review input to the user.

In some embodiments, each of the plurality of pump panel training devices includes a respective plurality of gages operable to imitate gages upon a fire truck pump panel and a respective plurality of simulated controls operable to imitate controls upon the fire truck pump panel. Each of the plurality of pump panel training devices further includes a respective camera device capturing a plurality of images of a respective user operating the pump panel training device and a respective display device.

In some embodiments, the at least one computerized processor evaluates the performance of each of the respective users, compares the performances of the respective users, and provides a training output based upon the comparing.

In some embodiments, the plurality of images of a first respective user is a plurality of images of a user operating a first of the plurality of pump panel training devices. The plurality of images of a second respective user is a plurality of images of an instructor operating a second of the plurality of pump panel training devices. The at least one computerized processor providing the training output based upon the comparing includes a display output comparing the user operating the first of the plurality of pump panel training devices to the instructor operating the second of the plurality of pump panel training devices.

In some embodiments, the at least one computerized processor providing the training output based upon the comparing includes providing a side-by-side illustration of the movements of the respective users or providing an illustration of the movements of a first of the respective users overlaid upon the movements of a second of the respective users.

In some embodiments, the at least one computerized processor further provides real-time instruction to the user.

According to one alternative embodiment, a system comprising a pump panel training device and a driver training device is provided. The system includes the pump panel training device. The pump panel training device includes a plurality of gages operable to imitate gages upon a firetruck pump panel and a plurality of controls operable to imitate controls upon the firetruck pump panel. The pump panel training device further includes a camera device capturing a plurality of images of a user operating the pump panel training device and a display device. The system further includes the driver training device operable to simulate driving operation of a fire truck. The system further includes one or more computerized processors coordinating data between the pump panel training device and the driver training device, receiving the plurality of images from the camera device, and providing a training output to the user through the display device based upon the plurality of images.

### BRIEF DESCRIPTION OF THE DRAWINGS

One or more embodiments will now be described, by way of example, with reference to the accompanying drawings, in which:

FIG. 1 schematically illustrates in a front view an exemplary first embodiment of a pump panel training device, in accordance with the present disclosure;

FIG. 2 schematically illustrates in a top view the pump panel training device of FIG. 1, in accordance with the present disclosure;

FIG. 3 schematically illustrates in a side view the pump panel training device of FIG. 1, in accordance with the present disclosure;

FIG. 4 schematically illustrates in a perspective view an exemplary second embodiment of a pump panel training device, in accordance with the present disclosure;

FIG. 5 schematically illustrates in a side view the pump panel training device of FIG. 4, in accordance with the present disclosure;

FIG. 6 illustrates an exemplary simulation system including a first pump panel training device, a second pump panel training device, and a supervisory computerized device, in accordance with the present disclosure;

FIG. 7 illustrates an exemplary alternative simulation system including a pump panel training device, a driver training device, a supervisory computerized device, and a remote server device, in accordance with the present disclosure;

FIG. 8 schematically illustrates components of an exemplary pump panel training device communicating over a communications bus, in accordance with the present disclosure;

FIG. 9 schematically illustrates an exemplary computerized processor useful to operate a pump panel training device, in accordance with the present disclosure;

FIG. 10 is a flowchart illustrating an example of a method which may be operated by one or more processors to evaluate operation of a pump panel training device and provide a training output based upon the evaluation, in accordance with the present disclosure;

FIG. 11 schematically illustrates a method useful to track and score movements of a trainee during a simulation operated upon a pump operation panel simulator, in accordance with the present disclosure;

FIG. 12 schematically illustrates an exemplary display screen providing a training output display to a user, in accordance with the present disclosure;

FIG. 13 schematically illustrates the pump panel training device of FIG. 1 in communication with an instructor's device, in accordance with the present disclosure;

FIG. 14 is a flowchart illustrating an example method for providing a plurality of images to an instructor, receiving an instructor review input from the instructor, and generating a training output to a user based upon the instructor review input, in accordance with the present disclosure;

FIG. 15 is a flowchart illustrating an example method for providing a plurality of images to an instructor, receiving an instructor review input from the instructor, scoring in parallel operation of the pump panel training device based upon inputs to and outputs generated by the pump panel training device, and generating a training output to a user based upon a combining of the instructor review input and the scoring, in accordance with the present disclosure;

FIG. 16 schematically illustrates a virtual reality visor that may be utilized with the disclosed system, an augmented reality enabled pair of glasses that may be utilized with the disclosed system, and an example of a glove equipped with a marker device that may be utilized with the disclosed system, in accordance with the present disclosure;

FIG. 17 schematically illustrates a portion of a pump panel training device equipped with a visually identifiable marker device and a portion reserved for projection of an image for use in operating a simulation upon the pump panel training device, in accordance with the present disclosure; and

FIG. 18 schematically illustrates operation of an exemplary artificial intelligence module to update evaluation of monitored user movements, in accordance with the present disclosure.

### DETAILED DESCRIPTION

### I—System Overview

Pump trucks and the associated pump equipment are complicated machinery. Skilled technicians working on the equipment use information from many different sources to confirm that the pump is working correctly, from visual information from gages and video displays, sound from the pump machinery, and tactile inputs such as vibrations in the pump housings and water pressures, temperatures, and oscillations in the fire hoses. A video screen only simulation would miss out on the complexities of the multiple senses needed to adequately monitor the pump equipment. Additionally, sound generated by electronic speakers is different from sounds generated from actual functioning equipment, missing directional queues and accompanying vibrations that give the operator a more complete sense of how the equipment is functioning.

Additional features may include a tandem/relay operation and dual pumping simulation. In real life fire-fighting, often a water source is not ideally located relative to the fire. Either the water source is too far away or height differential provides too much pressure loss to effectively fight the fire. To overcome these problems, multiple pumping trucks or pumping devices may be used in sequence and/or in parallel to feed water from the water source to a location where it is needed.

An embodiment of the disclosed pump operation panel simulator may include a plurality of pump panel training devices to simulate the connection of multiple pumping devices to deliver water from a water source to a destination where it is needed. Training for this kind of situation may be accomplished by using pump panel training devices that may support tandem/relay and dual pumping operations. In one embodiment, a simulation system may couple two or more pump panel training devices via network connection. Such a network of connected panel training device may provide a team training environment where one pump operator on one apparatus must compensate for the actions of another pump operator on another apparatus.

Input parameters to a simulation event may be preset as parameters to one of a sequence of training programs. In one exemplary embodiment, a series of pre-programmed simulation events of increasing difficulty may be provided with a pump panel training device. In another exemplary embodiment, a randomized simulation event may be operated, for example, with a trainee or an instructor being given an ability to establish a range of values or a likelihood of events occurring as part of the randomized simulation event. In another exemplary embodiment, an instructor operating a remote computerized device such as a laptop computer or a smart-phone may be given a supervisory application, enabling the instructor to monitor performance of the trainee and control inputs to the program, for example, prompting simulated occurrences such as an acute hose failure or interruption of a water source during a simulation event. Such a remote computerized device may be described as an instructor operator station. According to one embodiment, the primary responsibilities of the instructor may include selecting a pre-programmed simulation event, setting a hose configuration for a simulation event, monitoring progress of a simulation event, generating simulated malfunctions in simulated equipment during a simulation event, selecting programmed options for a simulation event, and preparing reports to summarize performance during a simulation event. Reports to summarize a trainee's performance may rate an effectiveness of delivering water to the location needing water (for example, summarizing an estimate of gallons delivered), describe equipment failures caused by the trainee, and failure by the trainee to follow particular instructions such as turning a discharge handle too quickly. According to one embodiment, a simulation event status display may be provided to the instructor, providing the instructor with copies of the gages visible to the trainee, representations of all control inputs manipulated by the trainee, a summary of all actions taken so far by the trainee, a summary of upcoming programmed events in the simulation event yet to occur, and options for making any equipment within the pump panel training device fail upon command of the instructor. For example, the instructor may be provided with a touch screen display, and the instructor may make any one of the gages visible to the trainee fail by touching the area of the touch screen display showing the gage.

Input parameters to a simulation event may include a wide variety of factors, including but not limited to information about water sources, water tank level, foam tank level, pump engine operation status, pump engine temperature, hose diameters, hose lengths, water usage of an outlet flow (for example, on/off status for one or more spray nozzles), ambient temperature and other ambient weather effects, water temperature, equipment failure status (for example, timed occurrence of hose blockage), and programmed events such as a radio message being played at a particular time.

Simulation event outputs may include gage readings; graphical images displayed upon an inset video monitor; graphical images displayed upon an external video monitor; sound outputs provided through an audio system; sound outputs provided through a simulated emergency radio system; vibratory outputs simulated, for example, through operation of a motor including an offset weight upon an motor output shaft; simulated water inlet parameters such as temperature, vibration, and hose inflation; simulated water outlet parameters such as temperature, vibration, and hose inflation; and warning and status lights.

A variety of control inputs may be incorporated in or attached to a pump panel training device. For example, a pump panel training device may include a lever, knob, or other control input for opening and closing a primary water inlet; a lever, knob, other control input for opening and closing a secondary water inlet; a lever, knob, other control input for opening and closing a pump inlet; a lever, knob, other control input for opening and closing each of a plurality of water outlets or discharge lines; a lever, knob, other control input for opening and closing each of a plurality of pre-connect lines; a lever, knob, other control input for opening and closing an on-board tank fill and recirculating line; a lever, knob, other control input for opening and closing an on-board tank to pump line; a lever, knob, other control input for opening and closing drain valves; a lever, knob, other control input for controlling priming the pump (removing air from a water pump inlet); a knob or other control input for controlling a pump engine throttle; controls operable to control flow of a fire-fighting foam to a pump; controls associated with a two stage pump; a horn control switch; and a knob or other control input for controlling a relief valve useful to control pump pressure. Other control inputs related to various other actual pump panel functions may additionally or alternatively be utilized. A control useful to simulate control of engine throttle may in one example include a n “OK-to-pump” indicator.

Visual outputs of a pump panel training device may include a number of exemplary outputs, including but not limited to: gages indicating simulated water pressure in a number of attached lines; gages indicating engine water temperature, engine oil pressure, and engine rotational speed; gages and associated controls simulating an engine governor device; gages indicating status of an on-board water tank and an on-board foam tank;

Audio outputs provided by a pump panel training device may include but are not limited to engine sounds that respond to throttle and pump load, primer sounds, cavitation sounds, tank fill overflow sounds, open drain valve sounds, pressure relief valve operation sounds, and warning sounds. Additionally or alternatively, the audio system may include an intercom permitting an instructor to interact with a trainee.

An inset video monitor may be attached to a face of a pump panel training device and may be used to simulate a variety of control panels that may be present upon an actual pump panel. Such an inset video monitor may include a touch screen display, enabling a trainee to interact with the controls that may be present upon an actual pump panel.

An external video monitor may be attached proximate to a pump panel training device, for example, with a rotating and/or extending arm enabling movement of the external video monitor relative to the pump panel training device. In this way, a trainee may be presented with an external video monitor in a separate viewing direction away from the pump panel training device, such that the trainee may be required to split attention between the external video monitor and the pump panel training device to simulate complicated scenarios that may occur relative to an actual pump panel. For example, an external video monitor may display a representation of a fire hydrant hookup, a dump-tank hookup, a scene including simulated fire-fighters, a scene including hoses leading up to and leading away from the pump panel training device, a scene including a distant second fire truck including a pump panel, or other similar environmental scenes that may require the attention of a pump panel operator. In one embodiment, the external video monitor may display a hose and nozzle layout schematic, providing the trainee with necessary information to understand the network of hoses attached to the pump panel training device.

Simulated hoses and hose systems may include a variety of embodiments. In one exemplary embodiment, a hose section of one to a few feet in length may include a threaded connection fitting on a first end (operable to be attached to an inlet or outlet fitting upon a pump panel training device) and a crimped or sealed end upon a second end. Such a sealed hose section attached to the pump panel training device may be filled with air or water, and that air or water may be heated, cooled, vibrated, and/or pressurized to simulate various conditions in the hose. In another exemplary embodiment, a length of hose with threaded fitting on both ends, may be attached to the pump panel training device, and water or air may be cycled through the hose to simulate various conditions in the hose. In one embodiment, an auxiliary pump device may be used to cycle water or air through the hose and condition the water or air (control temperature, create vibrations, control pressure, etc.)

A simulation event may be programmed in order to simulate attachment of hoses to a fire department connection (FDC) system, which may include a connection on an outside of a building which enables connected hoses to supply water to a building's interior standpipe or sprinkler system. Maintaining water pressure within a selected range may be required for proper operation of an FDC system. Parameters of a simulation event may instruct a trainee regarding how to maintain a discharge water pressure within such a selected range under varying conditions. In one exemplary embodiment, proper operation of the pump panel training device depends upon a simulated water demand, which may vary throughout a simulation event based upon which and how many sprinkler zones within a building are currently requiring a water flow.

Compressed air foam may be utilized in fire-fighting. The disclosed pump panel training device may simulate use of a compressed air foam system. A control input simulating control over a compressed air foam system may include an air valve control for each discharge

A dry hydrant is a device used in actual settings that includes pipes connected to a water source such as a pond. In contrast to fire hydrants in urban areas where the fire hydrant has access to pressurized water, dry hydrants are initially without water and enable a fire truck to draw water through the attached pipe from the water source to the dry hydrant. A simulation event may be programmed to test procedures to access water through a dry hydrant.

A simulation event builder program may be made available to an instructor, providing the instructor with an ability to program and save customized simulation events.

In one embodiment, the disclosed simulator may be operated in cooperation with an emergency vehicle driving simulator, such that performance and decisions made in the driving simulator affect parameters in the simulation incorporating the pump panel training device. For example, controls in a driver's cockpit must be activated prior to operation of a pump panel starting. A simulation event may coordinate between the simulators to determine and require that proper activation of the simulated controls in the cockpit occur prior to operation of the simulated pump panel. In another example, distance from a fire hydrant, distance from a fire-fighting scene, location in relation to a second truck with a pump panel, elevation of the truck in relation to a water source, and location in relation to a loud piece of equipment may all be used to simulate conditions in a simulation event. A data link between computerized controls of the driving simulation and the disclosed simulation incorporating the pump panel training device may exchange data related to various parameters, including but not limited to simulated engine RPM, power-take-off engagement, engine oil pressure, water temperature, and other data related to running or pausing the simulation event. Operation of a pump operation panel simulator including a pump panel training device is disclosed in commonly owned U.S. Pat. No. 11,583,716, which is hereby incorporated by reference.

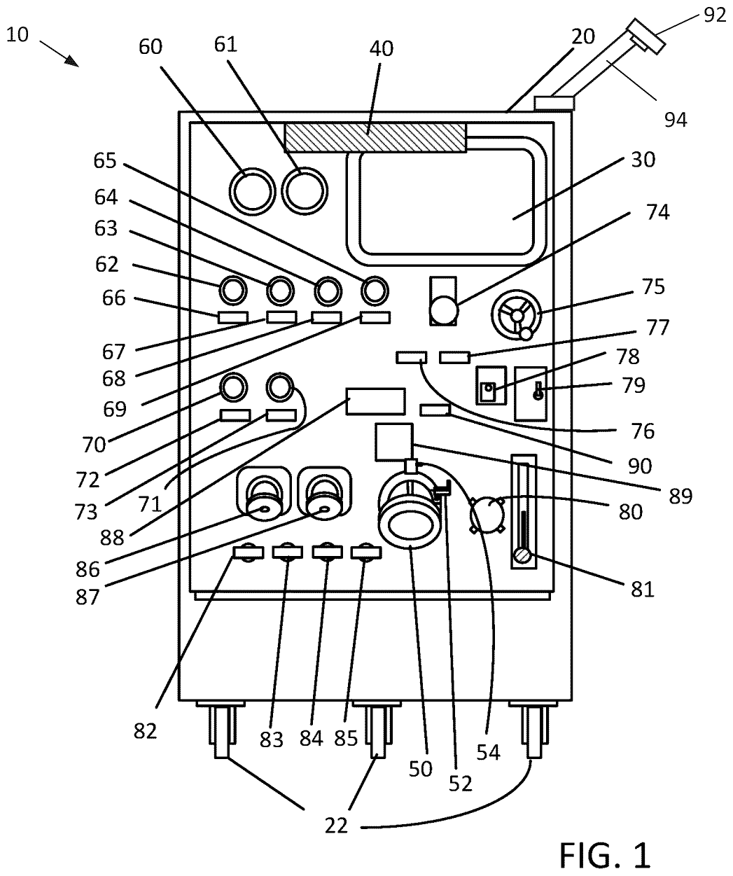

Referring now to the drawings, wherein the showings are for the purpose of illustrating certain exemplary embodiments only and not for the purpose of limiting the same, FIG. 1 schematically illustrates in a front view an exemplary first embodiment of a pump panel training device including a side mount pump panel training device. Pump panel training device 10 is illustrated including cabinet 20, display monitor 30, and audio speaker 40. Pump panel training device 10 includes a plurality of simulated controls, simulated outputs, and simulated connection fittings useful to train a trainee in operation of an actual pump panel training device. Simulated connection fittings include intake connection 50, simulating an exemplary five-inch diameter hose connection; preconnection fitting 80, simulating an exemplary 2.5-inch diameter hose connection; discharge connection 86, simulating an additional exemplary 2.5-inch diameter hose connection; and discharge connection 87, simulating an additional exemplary 2.5-inch diameter hose connection. Simulated outputs include master intake pressure gage 60, master discharge pressure gage 61, driver side preconnect pressure gage 62, driver side preconnect pressure gage 63, passenger side discharge (No. 2) pressure gage 64, deluge discharge pressure gage 65, driver side discharge (No. 1) pressure gage 70, and driver side discharge (No. 3) pressure gage 71. Simulated controls include driver side preconnect control knob 66, driver side preconnect control knob 67, passenger side discharge (No. 2) control knob 68, deluge discharge control knob 69, driver side discharge (No. 1) control knob 72, and driver side discharge (No. 3) control knob 73. Additionally, driver side discharge (No. 1) control knob 82, driver side discharge (No. 3) control knob 83, driver side preconnect control knob 84, and driver side preconnect control knob 85 are provided. Additionally, a pump intake shut-off lever 81 is provided. Additionally, an intake control valve knob 52 is provided. Additionally, an intake tap fitting 54 is provided. Additionally, pump priming controls 78, engine throttle controls 74, valve control knob 75, transfer valve control switch 79, tank file and recirculating line control knob 76, on-board tank to pump control knob 77, and manual pump priming control knob 90 are provided. Additionally, informational placard 88 and informational placard 89 are illustrated, providing important information for operation of the device.

Cabinet 20 includes a metallic box operable to house components of pump panel training device 10. Cabinet 20 may include wheels 22 operable to permit movement of pump panel training device 10.

Display 30 permits pump panel training device 10 to illustrate complex or optional displays depending upon a configuration of the simulation event being operated. For example, details regarding an optional compressed air foam system may be displayed upon display 30. Display 30 may include an exemplary liquid crystal display. Display 30 may include a touch-screen device capable of displaying information and receiving inputs through a trainee touching different parts of display 30. Display 30 may relay information to the trainee, for example, displaying a current level of an on-board water tank or a current level of an on-board foam tank. In one exemplary embodiment, at a conclusion of a simulation event, display 30 may display results of the simulation event to the trainee. In another embodiment, display 30 may provide a training video or timely instructions to the trainee to aid in instructing the trainee in a lesson or set of lessons. Such instructions may include real-time instructions, for example, in the context of monitored movement of the hands of the user.

Intake connection 50 is illustrated without any hose or hose portion connected to it for clarity of illustration. According to embodiments of the disclosure, a hose or a hose portion may be connected to intake connection 50, the hose or hose portion may be filled with a substance such as air or water, and heat, pressure, and vibration of the hose or hose portion may be controlled through a simulation event. In one embodiment, a trainee receiving high marks in a simulation event may depend upon the trainee sensing conditions in the hose and changing control input settings based upon the sensed conditions.

A camera device 92 may be connected to the cabinet 20 with a connecting arm 94. The camera device 92 may be configured to capture an image or a plurality or series of images of a user operating the pump panel training device 10. The camera device 92 may capture images in a visual light range and/or an infrared light range. The camera device 92 may include an illumination unit, for example, including a light emitting diode (LED) or a plurality of LEDs configured to emit light useful to capturing clear and distinct images of the user and the pump panel training device 10. One camera device 92 is illustrated, although a plurality of camera devices 92 may be utilized to enable accurate and precise computerized tracking of the user and interactions of the user with the pump panel training device 10. In one embodiment, the user may wear specialized gloves or other wearable devices which may include markers useful to enable a camera equipped tracking system to accurately track and estimate movement of the hands of the user.

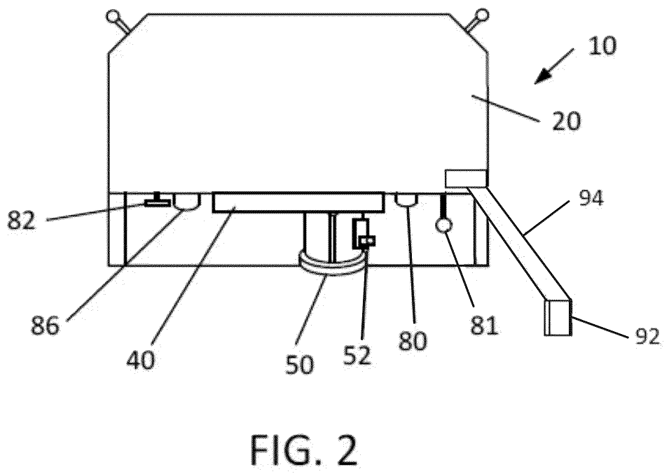

FIG. 2 schematically illustrates in a top view the pump panel training device of FIG. 1. Pump panel training device 10 is illustrated, including cabinet 20, intake connection 50, preconnection fitting 80, discharge connection 86, audio speaker 40, pump intake shut-off lever 81, intake control valve knob 52, and driver side discharge (No. 1) control knob 82. The camera device 92 and connecting arm 94 are additionally illustrated.

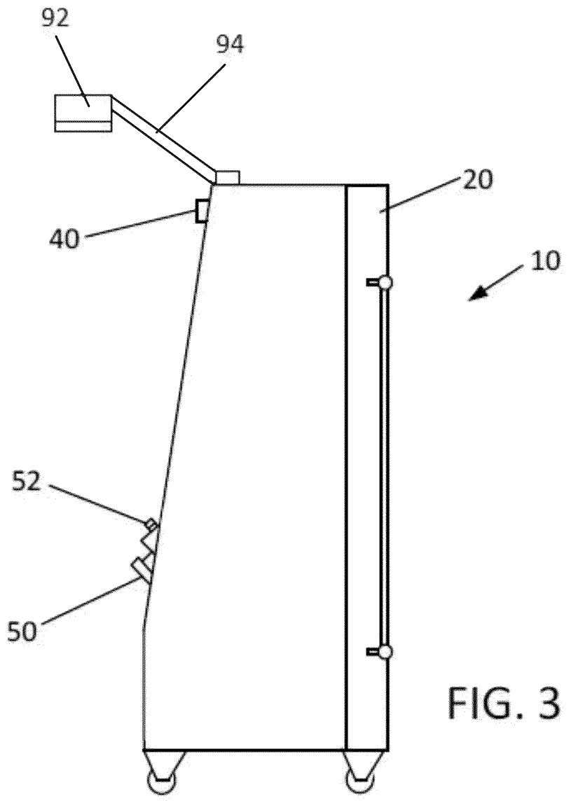

FIG. 3 schematically illustrates in a side view the pump panel training device of FIG. 1. Pump panel training device 10 is illustrated, including cabinet 20, audio speaker 40, intake connection 50, and intake control valve knob 52. The camera device 92 and connecting arm 94 are additionally illustrated.

Operation of the pump panel training device 10 may be monitored or evaluated through a simulation in a number of ways. For example, user inputs to controls such as knob 52 and lever 81 may be received as inputs to a computerized program, and the timing of these inputs may be judged, for example, according to time to react to an output, maximizing or minimizing a particular algorithm output (such as maximizing simulated water delivered or minimizing simulated pump vibration), or avoiding a particular simulated outcome, such as simulated pump cavitation. The camera device 92 may capture a plurality of images of the user operating the pump panel training device 10 and further utilize these images as inputs to the computerized program. For example, a procedure may require the user to feel a hose for simulated temperature at a certain point in the simulation. In another example, the program may require the user to have a hand placed on a particular lever by a particular time. The plurality of images may be analyzed or evaluated to determine compliance with program inputs and procedures in accordance with training protocols of the computerized program.

Evaluating or scoring the movements of the user may include tracking the movements of the user. For example, a marker may be disposed and configured to provide a location of the at least one hand of the user to the computerized processor through the plurality of images. A marker may be an object of known dimensions and surface pattern that a computerized program may be trained to identify in an image. By evaluating within the image the appearance of the marker, the position and/or orientation of the marker and the object upon which the marker is disposed may be determined or estimated. By providing the user with a glove with a marker attached to the glove, the images of the user may provide precise and accurate locations of the hand of the user, for example, in relation to the position of the pump panel training device, for the computerized program to evaluate.

The embodiment illustrated in FIGS. 1-3 is provided as an illustrative example of how a pump panel training device may be configured. It will be appreciated that a manufacturer of such a pump panel training device may change control, display, and connection fittings to simulate different actual pump panels. Actual controls, gages, and connection fittings may be fitted to cabinet 20 to increase realism, with internal electronics within cabinet 20 transforming computerized control signals and data within cabinet 20 into and from interactions with the controls, gages, and connection fittings situated upon the exterior of cabinet 20. A wide variety of cabinet and component configurations are envisioned, and the disclosure is not intended to be limited to the particular examples provided herein.

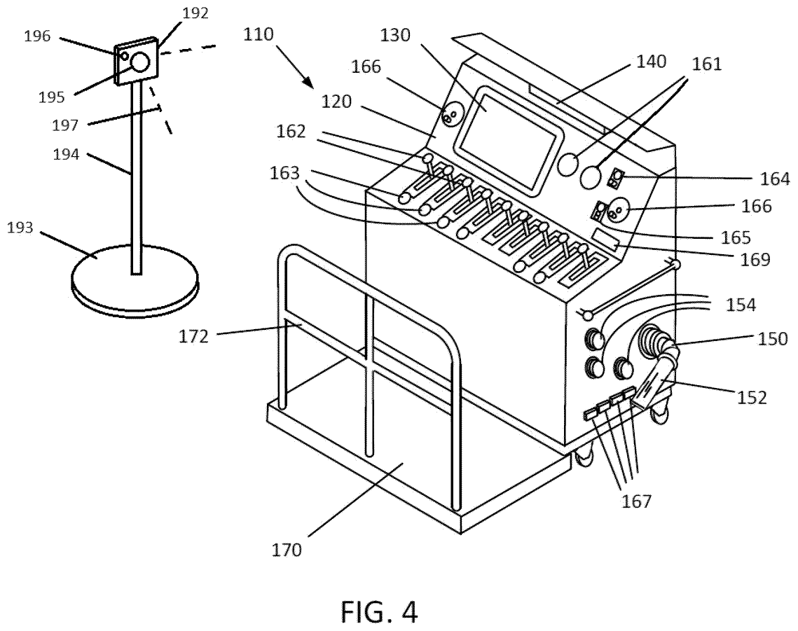

FIG. 4 schematically illustrates in a perspective view an exemplary second embodiment of a pump panel training device including a top mount pump panel training device. Pump panel training device 110 is similar to pump panel training device 10 of FIG. 1, with the exception that pump panel training device 110 is operable to simulate an actual pump panel training device that would be situated on a top of a fire truck instead of on a side of a fire truck. Pump panel training device 110 is illustrated including cabinet 120, display 130, audio speaker 140, trainee stand 170, and stand railing 172. Pump panel training device 110 includes a plurality of control levers 162 and control knobs 167 operable to simulate levers and knobs that exist on a similar actual pump panel training device. Further, pump panel training device 110 includes intake pressure gage 161, discharge pressure gage 161, and a plurality of pressure gages 163 operable to simulate pressure gages that exist on a similar actual pump panel training device. Pump panel training device 110 further includes a pair of valve control knobs 166, pump priming control 165, engine throttle control 164, and informational placard 169. Pump panel training device 110 further includes intake connection 150 and connections 154. Intake connection 150 includes an attached hose portion 152 including a hose portion with a round connection fitting on one end operable to attach to intake connection 150 and a sealed end on a second end. Cabinet 120 includes internal components that may fill hose portion 152 with a substance such as water or air and may heat, pressurize, and/or vibrate the substance to simulate conditions that occur on a hose connected to an actual pump panel during operation.

Additionally, a camera device 192 is illustrated including supporting arm 194 connected to base 193. The camera device 192 is illustrated including a lens 195 and an illuminating LED 196. The camera device 192 captures images in a field of view 197 including trainee movements taken during a simulation operated upon the pump panel training device 110. One camera device 192 is illustrated, although a plurality of camera devices 192 may be utilized to enable accurate and precise computerized tracking of the user and interactions of the user with the pump panel training device 110.

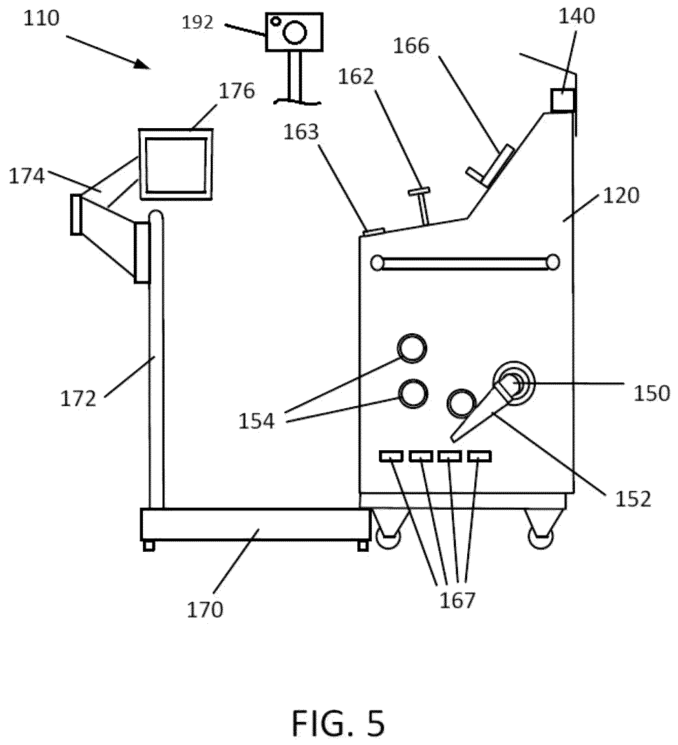

FIG. 5 schematically illustrates in a side view the pump panel training device of FIG. 4. Pump panel training device 110 is illustrated including cabinet 120, audio speaker 140, trainee stand 170, and stand railing 172. Pump panel training device 110 includes a plurality of control levers 162 and control knobs 167. Further, pump panel training device 110 includes plurality of pressure gages 163. Pump panel training device 110 further includes valve control knob 166. Pump panel training device 110 further includes intake connection 150 and connections 154. Intake connection 150 includes an attached hose portion 152. Additionally, camera device 192 is illustrated.

Pump panel training device 110 further includes an optional external display 176. External display 176 may be attached to any embodiment of a pump panel training device and at various locations on the pump panel training devices. Multiple external displays may be utilized on a single pump panel training device. External display 176 may include graphical displays useful to convey important information to a trainee, for example, including information about a water source that is being simulated or a hose configuration that is being simulated. External display 176 may be attached to pump panel training device 110 with an articulable arm 174.

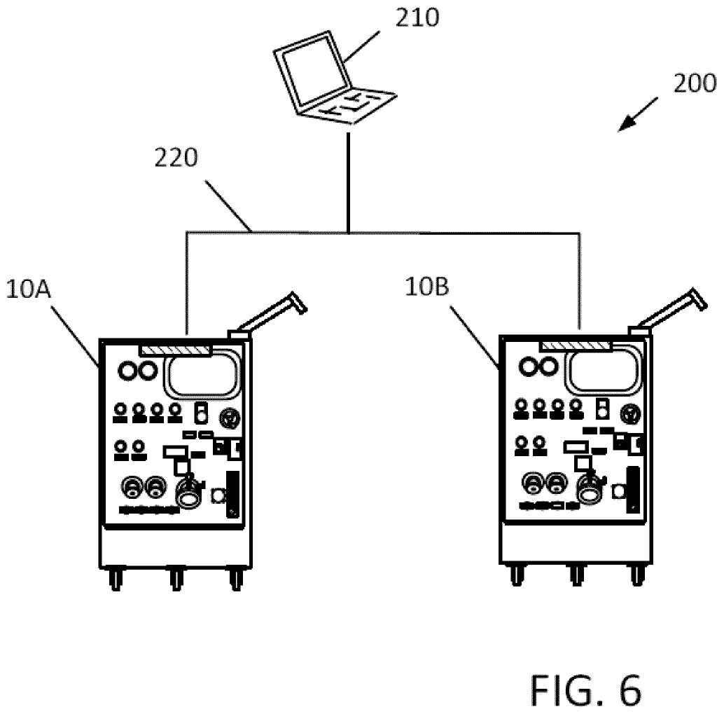

FIG. 6 illustrates an exemplary simulation system including a first pump panel training device, a second pump panel training device, and a supervisory computerized device. Simulation system 200 is illustrated including a first pump panel training device 10A, a second pump panel training device 10B, and supervisory computerized device 210. In one embodiment, two pump panel training devices may be utilized in a same location, with two separate simulation events being operated in parallel, with a single supervisory computerized device controlling parameters of both simulation events. In another embodiment, first pump panel training device 10A and a second pump panel training device 10B may be used to operate a cooperative simulation event, for example, with first pump panel training device 10A simulating drawing water from a water source and supplying an intermediate flow of water to second pump panel training device 10B, which simulates receiving the intermediate flow of water from first pump panel training device 10A and delivering the water to a destination that needs the water.

Use of supervisory computerized device is optional. In some configurations, an instructor may enter parameters for an upcoming simulation event directly into a display of a pump panel training device without use of a separate supervisory computerized device. Supervisory computerized device 210 may include any computerized device including a desktop computer, a laptop computer, a tablet computer, a smart phone device, or other similar computerized device.

FIG. 6 illustrates each of the illustrated pump panel training devices 10A, 10B equipped with a respective camera device 92A, 92B. Training programs may be operated to enable cooperative training of a first user and a second user simultaneously upon the pump panel training devices 10A, 10B. For example, in a first simulation configured to simulate two fire trucks operating simultaneously, with a first truck pumping water to a second truck, and with the second truck providing water to firefighters, the pump panel training devices 10A, 10B may be operated to train the first user and the second user to operate two fire trucks in this manner, simulating possible conditions and problems that fire fighters may face in such a two-truck operation. The camera devices 92A, 92B may be utilized to observe and track the movement of each of the users, may be used in a subsequent review video, for example, showing side-by-side performance of the users and instructing how the actions of the first user affected the conditions observed by the second user.

In a second simulation, two users may each operate the same simulation on the pump panel training devices 10A, 10B simultaneously. The respective camera devices 92A, 92B may track and record movements of the users, and a later review of the performances of the users may compare and/or overlay the movements of each of the users so that an instructor may show lessons that may be learned from the comparison.

In a third simulation, a trainee user may operate the pump panel training device 10A, while an expert instructor may operate the pump panel training device 10B. Actions of the instructor may be recorded and tracked and played via a video screen to the trainee in real time so that the trainee may copy the actions of the instructor. Lights that activate on the instructor's device may flash or otherwise indicate on the trainee's device so as to aid the trainee in following along with the instructor's actions. Actions of the trainee may be recorded and tracked and played to the instructor in real time so that the instructor may provide feedback to the trainee as the lesson progresses. Feedback such as gage readings and sounds heard by the trainee may be replicated upon the instructor's device to aid the instructor in providing timely feedback. Display 30 on the trainee's device may show a side-by-side comparison of the trainee's tracked motions and the instructor's tracked motions so as to enable a visual comparison of the technique being performed. In such a way, the pump panel training device 10A and the pump panel training device 10B may be remotely located while enabling an instructor to provide hands-on, live, on-the-machine instruction to the trainee.

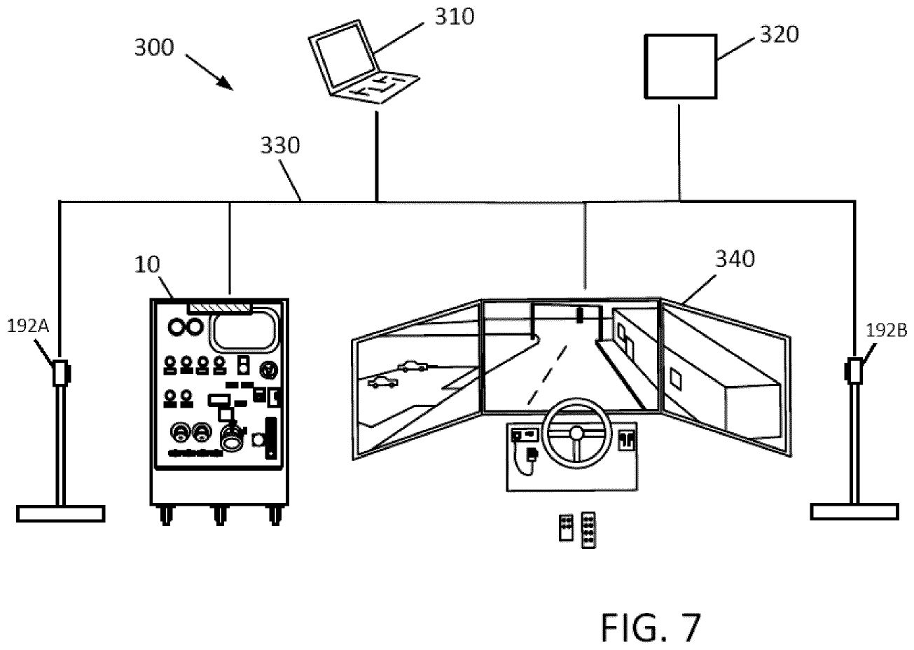

FIG. 7 illustrates an exemplary alternative simulation system including a pump panel training device, a driver training device, a supervisory computerized device, and a remote server device. Simulation system 300 is illustrated including a pump panel training device 10, a driver training device 340, supervisory computerized device 310, and remote server device 320. Pump panel training device 10 and driver training device 340 may be used to operate a cooperative training event, for example, with performance of the driver trainee affecting parameters for the pump panel trainee.

A first camera device 192A and a second camera device 192B are illustrated monitoring movements of trainees using the simulation system 300. One or a plurality of camera devices 192A, 192B may be utilized, depending upon locations and orientations of the pump panel training device 10 and the driver training device 340. In one embodiment, the trainee or trainees may wear gloves, adhesive stickers, wrist bands, or other similar apparel that may have printed markers upon them with unique orientations of marker details. Markers are used in the art to aid camera tracking systems in monitoring and determining locations and orientations of objects being tracked within a field of view. In another embodiment, the simulation system 300 may use image recognition software to recognize location and orientation of hands of the trainee without the use of markers.

Use of a remote server device 320 is optional. A remote server device may be operated by a manufacturer of the system or by a large municipality operating a number of fire stations. Remote server device 320 may operate a pre-programmed set or sequence of simulation events. Remote server device 320 may provide a set of localized rules and protocols for particular regions or fire departments. Remote server device 320 may monitor and report simulation results. Remote server device 320 may provide assistance during simulation events, for example, with an expert standing by to provide guidance to trainees or technical experts standing by to answer questions about the system.

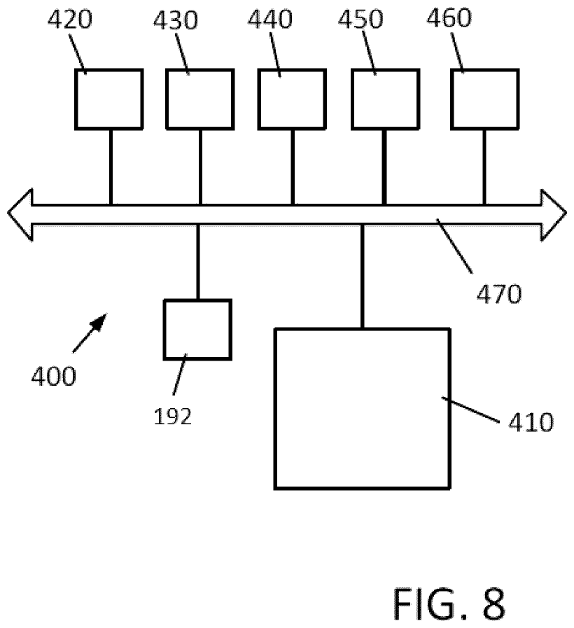

FIG. 8 schematically illustrates components of an exemplary pump panel training device communicating over a communications bus. Pump panel training device data communication system 400 is illustrated. Computerized pump panel control device 410 is located within a pump panel training device and is illustrated including a computerized processor operable to operate code and provide functionality related to simulation events. Communications bus 470 is a device useful to provide data communication between components of a system. Gage controller 420, control input controller 430, display controller 440, audio control 450, hose portion controller 460, and camera device 192 are illustrated connected to communications bus 470. Each of gage controller 420, control input controller 430, display controller 440, audio control 450, and hose portion controller 460 include electronic and/or electromechanical devices useful to provide functionality to the simulated gages, controls, and connection fittings of the pump panel training device. The camera device 192, as described herein, is useful to track and provide a series of electronic images of movements of a trainee during a simulation.

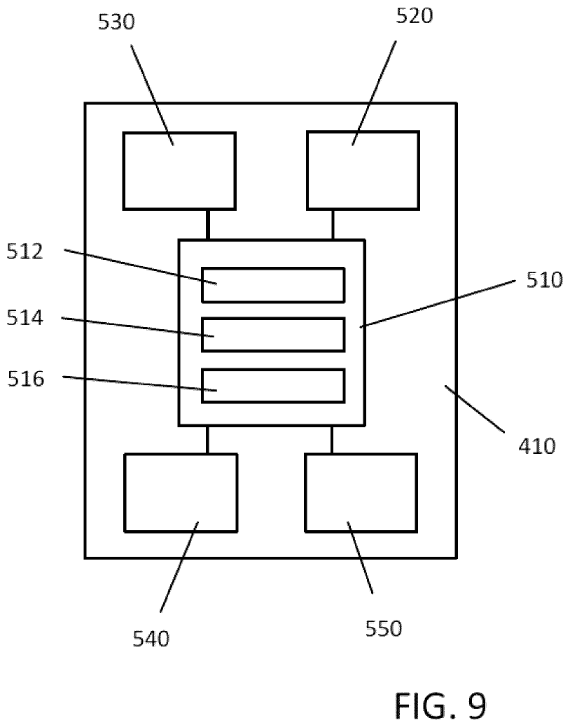

FIG. 9 schematically illustrates an exemplary computerized processor useful to operate a pump panel training device. Computerized pump panel control device 410 is illustrated, including processor device 510, durable memory storage device 550, communication device 520, input module 530, and output module 540.

Processor device 510 includes a computing device known in the art useful for operating programmed code. Processor device 510 includes random-access memory (RAM) and may access stored data through connection to memory storage device 550. Memory storage device 550 may include a hard drive, flash drive, or other similar device capable of receiving, storing, and providing access to digital data. Memory storage device may include user data, map data, equipment information, rules and procedures data, scores and results data, and any other data necessary to operate the disclosed simulation events.

Processor device 510 includes programming modules including simulation event module 512, user tracking and movement analysis module 514, and scoring module 516 which represent programmed functions that are exemplary of processes that may be carried out within processor device 510 but are intended to be non-limiting examples of such processes. Simulation event module 512 includes programming and data operable to operate the described pump panel simulation events, monitor control inputs, determine event parameters such as resulting pressures in lines, and determine output data such as gage readings and hose portion control parameters. User tracking and movement analysis module 514 includes programming to monitor movements of the user(s) involved in a simulation and their interaction with the disclosed equipment. Module 514 may include software enabling video playback of the user(s), for example, useful in creating side-by-side video comparisons, overlays of a first user's performance to a second user's performance, or video of the user's motions in reference to resulting simulated operation of the equipment. Scoring module 516 compares simulated operation of the pump panel training simulator to programmed criteria. Scoring module 516 may include software configured to enable tracking of hands of the trainees being scored and may compare tracked movement of the trainees to desired movement associated with a defined simulation program. Module 516 may include software configured to combine an evaluation of hand movements of the user with a simulation score generated based how the plurality of inputs to the pump panel training device are controlled by the user and/or how the outputs provided by the gages report resulting simulated operation of the pump panel training device. Module 516 may receive and process instructor review inputs for use in generating a training output. Module 516 may generate a training output for display to the user as described herein. Modules 512, 514, and 516 may include any related programming and related processes and are intended only as non-limiting examples of how the system could be configured.

Input module 530 include any devices or mechanisms useful to receive trainee and instructor input to modulate operation of the simulation event, and may include but are not limited to simulated knobs, levers, buttons, and inputs to a touch screen display.

Output module 540 include any devices or mechanisms useful to provide outputs to display screens, gages, hose portions, audio speakers, and other devices necessary to provide output to the driver or instructor.

Communication device 520 includes any wired or wireless communication system required to send and receive data from the computerized device.

The disclosed system may include an exemplary hose portion connected to an intake connection of a pump panel training device. The hose portion may be inert, for example, including an empty hose or a hose filled with a foam material configured to simply provide a filled or round form to the hose. In another embodiment, the hose may be energized with air or water to provide a simulated hose providing tactile feedback to the user. The pressure of the air or water within the hose may be controlled. Temperature and vibration of the air or water may additionally be controlled. Further, noise may be controlled, for example, providing the trainee with inputs that should be responded to, such as a sound imitating a command being issued by a supervisor or a water leak in the simulated attached hoses.

The disclosed system may utilize secondary computerized devices to expand or augment conditions of the simulation. For example, a display screen or a plurality of display screens may provide the trainee with context to a simulated environment around the system. A touchscreen or smartphone device may provide the trainee with an ability to provide inputs to the simulation, such as providing selectable verbal responses that the trainee may provide to simulation prompts, providing context to the simulation (e.g., “Training Segment 2 Complete—Beginning Segment 3”), and enabling the trainee to pause the simulation. A virtual reality headset may be utilized to provide virtual reality or augmented reality experiences for the trainee such as providing simulated details to the simulation such as virtual gauge displays and a virtual assistant walking the trainee through portions of the simulation.

### II—Pump Operation Panel Simulator Including a Trainee Review Method and System

Movement of an emergency responder during emergency operations in the field may be important to achieving a desired result. For instance, firemen within a burning building may be depending upon a pump operator to quickly establish and reliably maintain water pressure within the hose supplying water to the firemen. Wasted movements cost time. Movements in an incorrect order may result in delays, equipment failure, or other issues. Training a pump operator may benefit from tracking movement of the trainee during a training simulation. A pump operation panel simulator including a trainee review system and method are provided including a camera device or an imaging device useful to monitor and score movements of the trainee during a simulation.

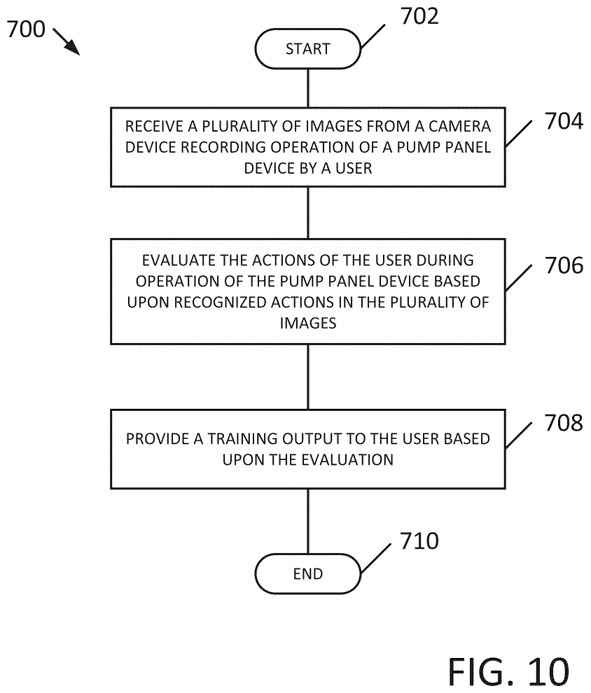

FIG. 10 is a flowchart illustrating an example of a method 700 which may be operated by one or more processors to evaluate operation of a pump panel training device and provide a training output based upon the evaluation. The pump panel training device may include the pump panel training device 10 of FIG. 1, the pump panel training device 110 of FIG. 4, or another similar device. One or more camera devices 92, 192 may be utilized to track movements of the trainee(s). The method 700 starts at step 702. At step 704, the one or more processors may receive a plurality of images form a camera device recording operation of the pump panel training device by a user. At step 706, the one or more processors may evaluate the actions of the user during operation of the pump panel training device based upon recognized actions in the plurality of images. At step 708, the one or more processors may provide a training output to the user based upon the evaluation. At step 710, the method 700 ends. The method 700 is provided as an example of a method for evaluation operation of a pump panel training device by a user and providing a training output to the user. A number of additional and/or alternative method steps are envisioned, and the disclosure is not intended to be limited to the examples provided herein.

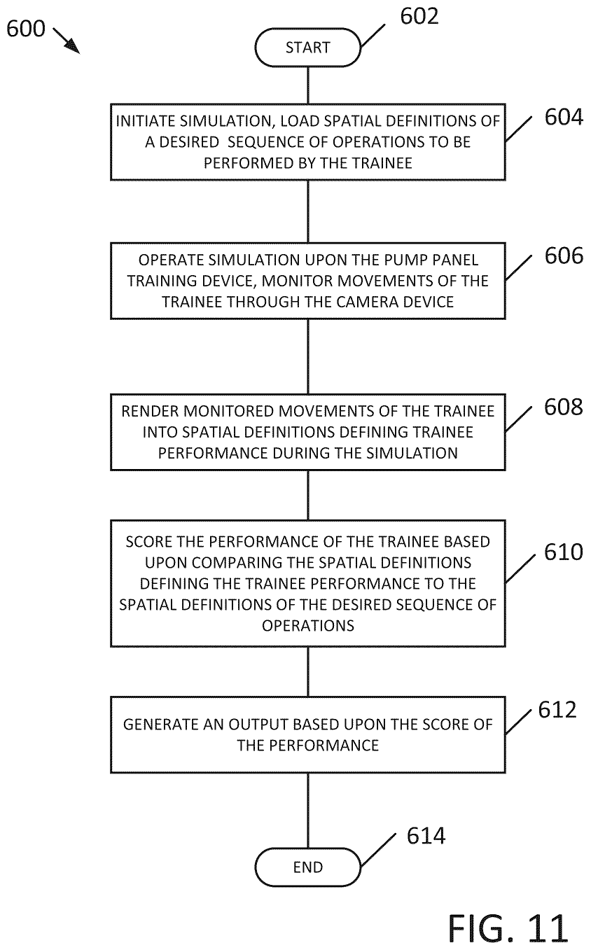

FIG. 11 is a flowchart illustrating an example of a method 600 useful to track and score movements of a trainee during a simulation operated upon a pump operation panel simulator. The pump operation panel simulator may include the pump panel training device 10 of FIG. 1, the pump panel training device 110 of FIG. 4, or another similar device. One or more camera devices 92, 192 may be utilized to track movements of the trainee(s). The method 600 starts at step 602. At step 604, a simulation is initiated, and a set of spatial definitions of or defining a desired sequence of operations to be performed by the trainee during the simulation is loaded. At step 606, the simulation is operated upon the pump operation panel simulator, and the camera device 92, 192 is utilized to track movements of the trainee during the simulation. At step 608, the tracked movements of the trainee are rendered into spatial definitions defining trainee performance during the simulation. At step 610, the performance of the trainee is scored by comparing the rendered spatial definitions defining the trainee performance to the spatial definitions of the desired sequence of operations. At step 612, an output is generated based upon the comparing. At step 614, the method 600 ends. The method 600 is provided as an example of a method for comparing tracked movements of the trainee during the simulation to a desired set of movements associated with the simulation. A number of additional and/or alternative method steps are envisioned, and the disclosure is not intended to be limited to the examples provided herein.

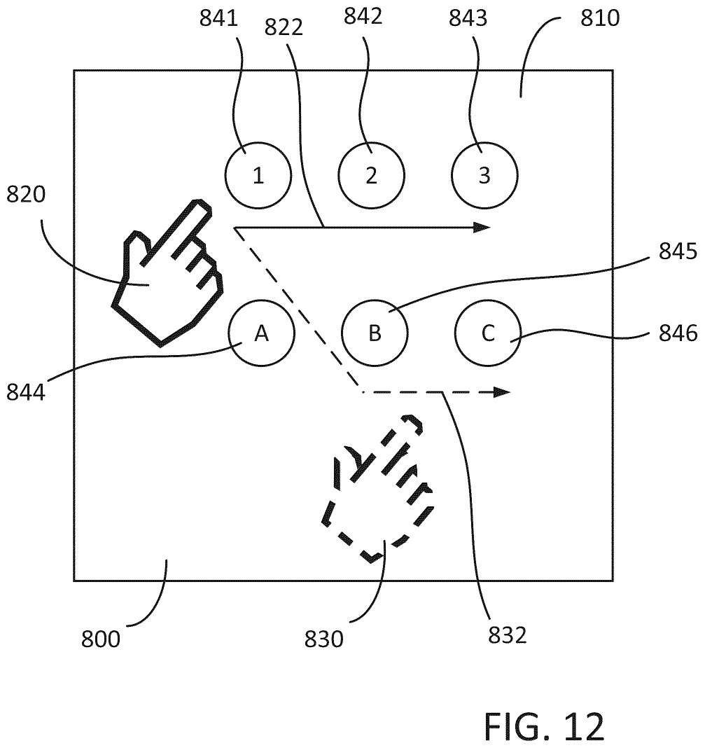

FIG. 12 schematically illustrates an exemplary display screen 800 providing a training output display 810 to a user. The exemplary display screen may include a display screen 30 as is illustrated in FIG. 1 installed to a pump panel training device 10. The display screen 800 may be a separate display, for example, mounted to the wall of a classroom or may be the user's personal computer screen or the screen of a cellular device. Hand 820 of the user is illustrated. The hand 820 may be directly taken from images taken by a camera device while the user was operating a pump panel training device. In another embodiment, the hand 820 may be a virtual image of the hand of the user rendered based upon position data of the user's hand over time through analysis of one or more plurality of images captured of the user's hand. The hand 820 is illustrated following a path over three exemplary control inputs 841, 842, 843 in succession, illustrating the movement of the user's hand along movement path 822 during operation of a simulation. A training hand 830 is additionally illustrated, moving along movement path 832, interacting with exemplary control inputs 841, 844, 845, and 846 in succession. In one embodiment, the movement of the hands 820, 830 may be illustrated simultaneously. In another embodiment, the movement of the hands 820, 830 may be illustrated in succession, in repetition, and/or including explanatory text and/or audio feedback. A number of training output displays 810 are envisioned, including a wide range of actions and movements that a trainee may be required to learn, and the disclosure is not intended to be limited to the examples provided herein.

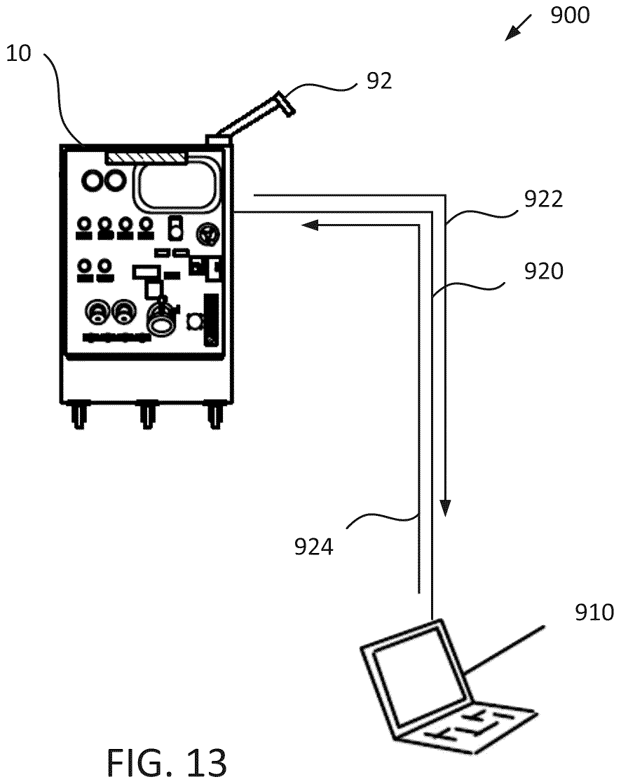

FIG. 13 schematically illustrates a configuration 900 including the pump panel training device 10 of FIG. 1 in communication with an instructor's device 910, wherein the pump panel training device 910 is configured to provide a plurality of images of a user operating the pump panel training device 10 to the instructor's device 910, and wherein the instructor's device 910 is configured to display the images to an instructor, receive an instructor review input from the instructor, and provide the instructor review input to the pump panel training device 10 for use in generating a training output to the user of the pump panel training device 10. The pump panel training device 10 is illustrated including the camera device 92. A communication connection 920 is illustrated connecting the pump panel training device 10 and the instructor's device 910. While the communication connection 920 is illustrated as a line which may represent a wired connection, the devices may alternatively be connected through wireless communication. A first communication 922 including the plurality of images captured by the camera device 92 is illustrated being communicated from the pump panel training device 10 to the instructor's device 910. A second communication 924 including the instructor review input provided by the instructor to the instructor's device 910 is illustrated being communicated to the pump panel training device 10. In an alternative embodiment, the instructor's device 910 may process the instructor review input and provide a training output to the pump panel training device 10 for display.

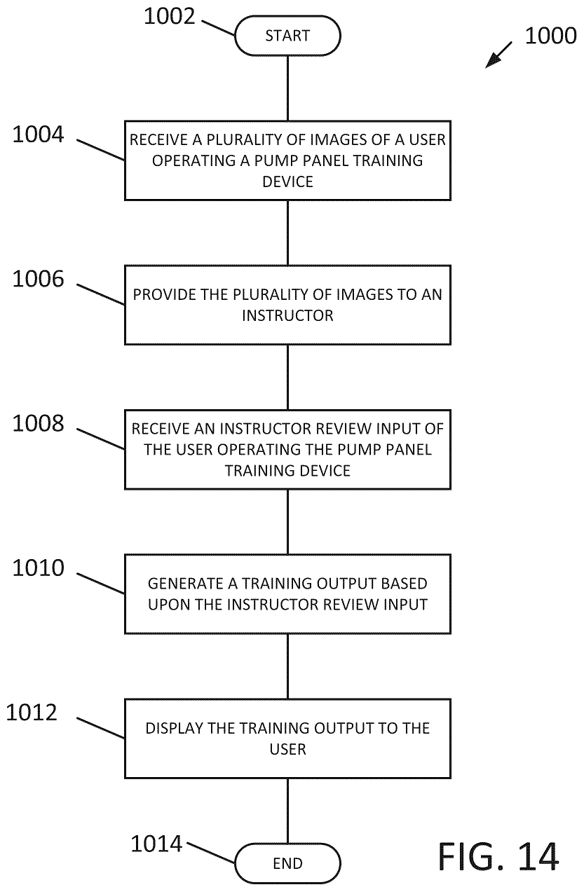

FIG. 14 is a flowchart illustrating an example method 1000 for providing a plurality of images to an instructor, receiving an instructor review input from the instructor, and generating a training output to a user based upon the instructor review input. The method 1000 may be operated by one or more processors to evaluate operation of a pump panel training device and provide a training output based upon the evaluation. The pump panel training device may include the pump panel training device 10 of FIG. 1, the pump panel training device 110 of FIG. 4, or another similar device. One or more camera devices 92, 192 may be utilized to track movements of the trainee(s). The method 1000 starts at step 1002. At step 1004, a plurality of images of a user operating a pump panel training device is received. At step 1006, the plurality of images is provided to an instructor for manual evaluation. At step 1008, the instructor provides an instructor review input grading or scoring the movement and performance of the user based upon the plurality of images. At step 1010, a training output is generated based upon the instructor review input. At step 1012, the training output is displayed to the user. At step 1014, the method 1000 ends. The method 1000 is provided as an example of how an instructor may perform a manual review of the plurality of images of the user. A number of additional or alternative method steps are envisioned, and the disclosure is not intended to be limited to the examples provided herein.

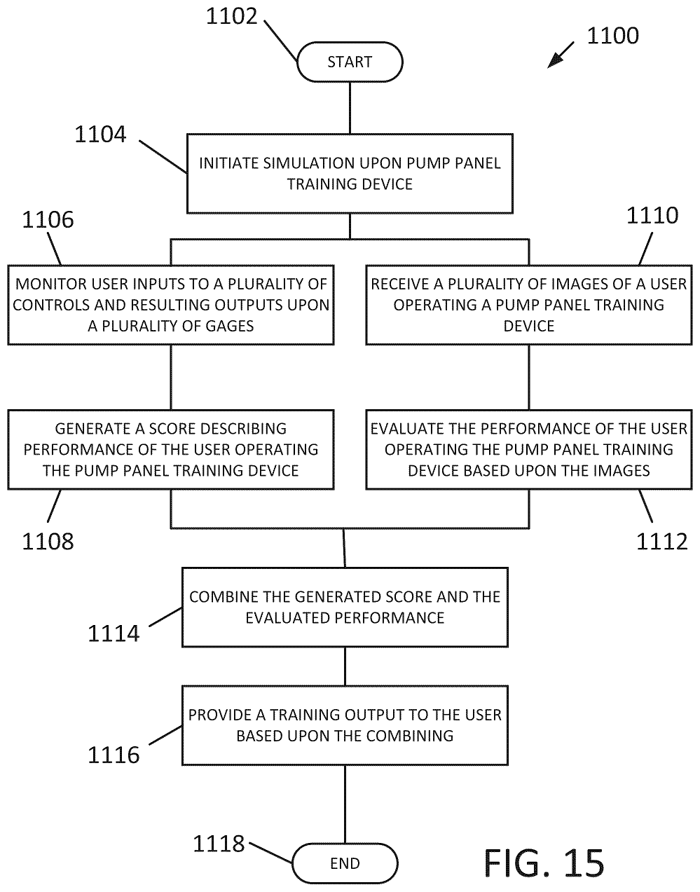

FIG. 15 is a flowchart illustrating an example method 1100 for providing a plurality of images to an instructor, receiving an instructor review input from the instructor, scoring in parallel operation of the pump panel training device based upon inputs to and outputs generated by the pump panel training device, and generating a training output to a user based upon a combining of the instructor review input and the scoring. The method 1100 may be operated by one or more processors to evaluate operation of a pump panel training device and provide a training output based upon the evaluation. The pump panel training device may include the pump panel training device 10 of FIG. 1, the pump panel training device 110 of FIG. 4, or another similar device. One or more camera devices 92, 192 may be utilized to track movements of the trainee(s). The method 1100 starts at step 1102. At step 1104, a simulation upon a pump panel training device is initiated. At step 1106, a user inputs to plurality of controls upon the pump panel training device and resulting outputs generated upon a plurality of gages resulting from the simulation are monitored. At step 1108, a score of the user operating the pump panel training device based upon the monitored inputs to the controls and outputs upon the gages is determined. In parallel to monitoring operation of the simulation upon the pump panel training device, at step 1110, a plurality of images of a user operating the pump panel training device is received. At step 1112, an evaluation of the performance of the user operating the pump panel training device based upon the plurality of images is performed. The evaluation may be a manual review conducted by an instructor or an automatically performed evaluation based upon a computerized analysis of the movements of the user. At step 1114, the generated score from step 1108 and the evaluation from step 1112 are combined. At step 1116, a training output is provided based upon the combination. At step 1118, the method 1100 ends. The method 1100 is provided as an example of how a plurality of scores and evaluations may be combined to create a training output. A number of additional or alternative method steps are envisioned, and the disclosure is not intended to be limited to the examples provided herein.

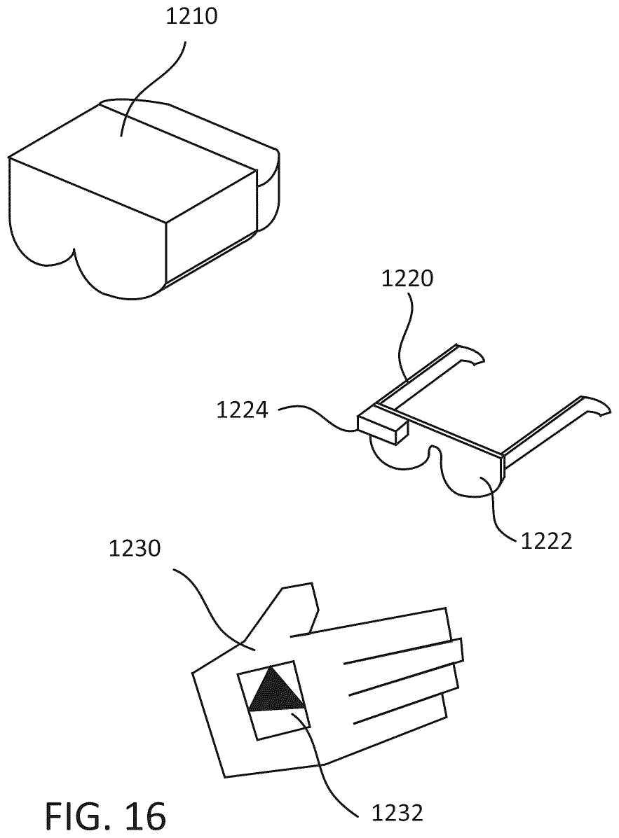

FIG. 16 schematically illustrates a virtual reality visor 1210 that may be utilized with the disclosed system, an augmented reality enabled pair of glasses 1220 that may be utilized with the disclosed system, and an example of a glove 1230 equipped with a marker device 1232 that may be utilized with the disclosed system. The virtual reality visor 1210 may provide an alternative view to a user, for example, entirely recreating a view of the pump panel training device 10 of FIG. 1 within the visor. The plurality of controls of the pump panel training device 10 may be reproduced in the virtual reality simulation, with actual tactile inputs to the controls being used as inputs to the virtual reality simulation. In the alternative, the augmented reality pair of glasses 1220 enables one to see through lenses 1222 of the augmented reality pair of glasses 1220, while a projector device 1224 upon the augmented reality pair of glasses 1220 projects graphics upon the lenses 1222 in the context of the objects being viewed through the lenses 1222.

The glove 1230 is illustrated including an exemplary marker 1232 including a visually perceptible pattern which may be utilized by a processor to determine a position and orientation of the glove 1230 within a coordinate system. The processor may, for example, establish such a coordinate system in the context of visible features upon such objects as the pump panel training device 10 of FIG. 1 or the pump panel training device 110 of FIG. 4. By establishing the coordinate system and then using the marker 1232 of the glove 1230, excellent accuracy and precision of determining a location and orientation of a hand of the user may be achieved.

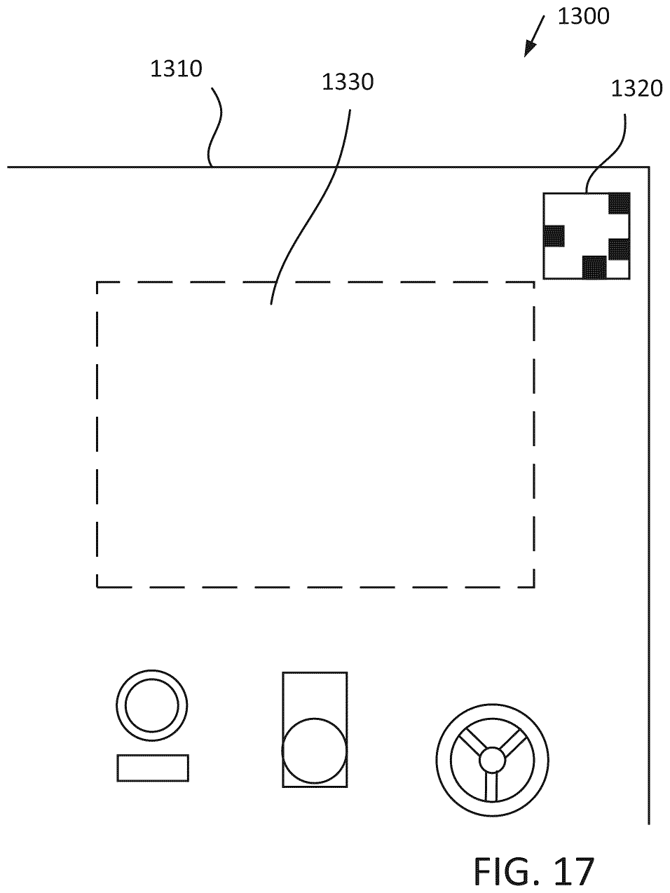

FIG. 17 schematically illustrates a configuration 1300 including a portion of a pump panel training device 1310 equipped with a visually identifiable marker device 1320 and a portion 1330 of the face of the pump panel training device 1310 reserved for projection of an image for use in operating a simulation upon the pump panel training device. The marker device 1320 may be utilized to establish a three-dimensional coordinate system based upon a location and orientation of the face of the pump panel training device 1310. A device, such as the augmented reality pair of glasses 1220 of FIG. 16, may be utilized to project desired images, such as virtual gages, virtual controls, or a display output upon the pump panel training device 1310 for viewing by the user operating the pump panel training device 1310.

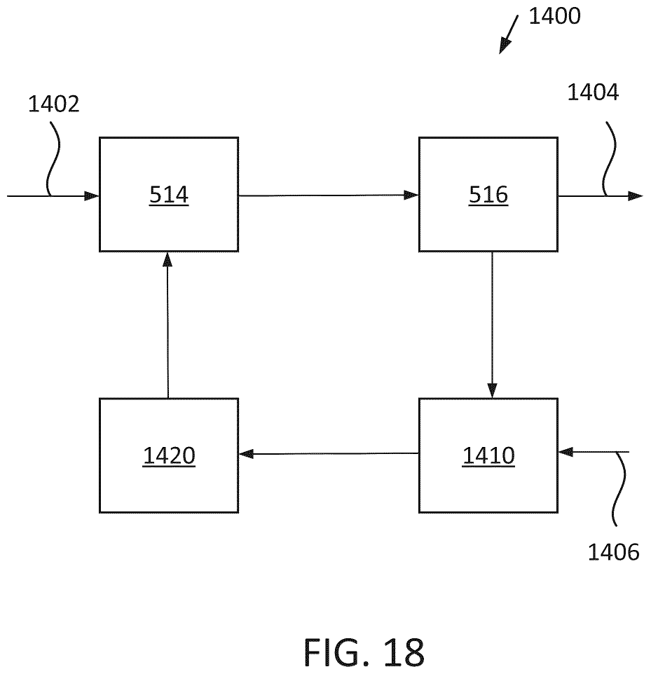

FIG. 18 schematically illustrates operation of an exemplary artificial intelligence subroutine 1400 to update evaluation of monitored user movements. The artificial intelligence subroutine 1400 may be operated within the processor device 510 of FIG. 9. The artificial intelligence subroutine 1400 may alternatively be operated across a plurality of processors. The artificial intelligence subroutine 1400 includes the user tracking and movement analysis module 514 and the scoring module 516 of FIG. 9. The artificial intelligence subroutine 1400 further includes an outcome evaluation module 1410 and an artificial intelligence module 1420. An input 1402 including data related to movement of the user during operation of the pump panel training device 10, 110 of FIG. 1 or 4 is illustrated being provided to the user tracking and movement analysis module 514. The user tracking and movement analysis module 514 may be initially trained with programming according to initial rules and judgment criteria for evaluating the movements of the user. A processed output is provided by the user tracking and movement analysis module 514 to the scoring module 516. The scoring module 516 provides an output 1404 which may include a training output for display to the user. Additionally, the scoring module 516 may further provide an output to the outcome evaluation module 1410. The output 1404 of the scoring module 516 is evaluated or judged. This evaluation may be automatically performed, for example, by criteria such as critical timing factors and outputs generated by the pump panel training device, for example, judging whether the movements of the user resulted in highly rated simulated operation of the pump panel training device 10, 110. In the embodiment of FIG. 18, an instructor or programmer may provide an outcome evaluation input 1406 to the outcome evaluation module 1410. The outcome evaluation input 1406 may be binary or scalar and may be single-factored or multi-factored. Positive or negative reinforcement of the output 1404 of the scoring module 516 may be provided to the artificial intelligence module 1420. The artificial intelligence module 1420 may utilize machine learning techniques used in the art to provide training factors to the movement analysis module 514 to improve accuracy and provide excellent performance of the output 1404 in later iterations of evaluating user movements over multiple cycles. The provided operation of the artificial intelligence subroutine 1400 is provide as an example. A number of additional or alternative operations are envisioned, and the disclosure is not intended to be limited to the examples provided.

A number of variations of outputs are envisioned related to providing the scoring to the trainee and/or a training instructor. Scores may be generated as number values, for example, with a total score earned out of a total possible score. Scores may be provided as color coded descriptions of each of several distinct desired operations or movements that the trainee was to have performed, with a selected color such as green indicating conforming movement of the trainee, with a second selected color such as red indicating non-conforming movement of the trainee, and with a third color, yellow, indicating borderline conforming or questionable movement of the trainee during the simulation. A playback video of the simulation including indications of the tracked movement of the trainee may be operable by a training instructor, for example, permitting the instructor to pause, rewind, play forwards or backwards, etc. the recorded movement of the trainee. A semi-transparent or overlaid image of an exemplary “perfect” trainee may be simultaneously played back, showing the trainee how his/her movements deviated from the “perfect” trainee may be utilized.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A pump panel training device, comprising:
a plurality of gages operable to imitate gages upon a firetruck pump panel;
a plurality of controls operable to imitate controls upon the firetruck pump panel;
a camera device capturing a plurality of images of a user operating the pump panel training device;
a display device; and
one or more computerized processors:
receiving the plurality of images from the camera device; and
providing a training output to the user through the display device based upon the plurality of images.

2. The pump panel training device of claim 1, wherein the one or more computerized processors further:
provides the plurality of images to an instructor; and
receives an instructor review input of the user operating the pump panel training device; and
wherein providing the training output to the user includes providing the instructor review input to the user.

3. The pump panel training device of claim 2, wherein the one or more computerized processors further:
monitors the user operating the pump panel training device, wherein the monitoring includes:
monitoring user inputs to the plurality of controls;
monitoring resulting outputs generated upon the plurality of gages; and
scoring a performance of the user based upon the monitored user inputs or the monitored resulting outputs.

4. The pump panel training device of claim 3, wherein the providing the training output includes combining the instructor review input to the user and the scored performance.

5. The pump panel training device of claim 1, wherein the one or more computerized processors further automatically evaluates the user operating the pump panel training device based upon the plurality of images.

6. The pump panel training device of claim 5, wherein automatically evaluating the user operating the pump panel training device includes:
initiating a simulation including identifying a set of spatial definitions defining a desired sequence of operations to be performed by a trainee during the simulation;
operating the simulation upon the pump panel training device including monitoring movements of the user through a camera device;
rendering the monitored movements of the user into spatial definitions defining performance of the user during the simulation;
scoring the performance of the user based upon comparing the spatial definitions defining the performance of the user to the spatial definitions defining the desired sequence of operations; and
generating an output based upon the scoring.

7. The pump panel training device of claim 5, wherein evaluating the user operating the pump panel training device includes:
monitoring movements of the user through the camera device;
scoring a performance of the user based upon comparing the monitored movements of the user to initial judgment criteria;
evaluating an outcome of the scoring and updating judgment criteria with an artificial intelligence subroutine; and
utilizing the updated judgment criteria during subsequent iterations of scoring the performance of the user.

8. The pump panel training device of claim 5, wherein the one or more computerized processors evaluating the user operating the pump panel training device includes the one or more computerized processors tracking movement of at least one hand of the user.

9. The pump panel training device of claim 8, further comprising a marker device disposed and configured to provide a location of the at least one hand of the user to the computerized processor through the plurality of images.

10. The pump panel training device of claim 5, wherein the computerized processor evaluating the user operating the pump panel training device includes scoring movement of a hand of the user in comparison to desired hand movement.

11. The pump panel training device of claim 10, wherein the computerized processor evaluating the user operating the pump panel training device includes scoring the performance of the user in comparison to desired operation of the pump panel training device.

12. The pump panel training device of claim 5, wherein the computerized processor evaluating the user operating the pump panel training device includes comparing movement of a hand of the user in comparison to recorded movement of an instructor operating the pump panel training device.

13. A system comprising a plurality of pump panel training devices, comprising:
the plurality of pump panel training devices, wherein at least one of the pump panel training devices includes:
a plurality of gages operable to imitate gages upon a fire truck pump panel;
a plurality of controls operable to imitate controls upon the fire truck pump panel;
a camera device capturing a plurality of images of a user operating the pump panel training device; and
a display device;
at least one computerized processor:
operating to coordinate data between the plurality of pump panel training devices;
receiving the plurality of images from the camera device; and
providing a training output to the user through the display device based upon the plurality of images.

14. The system of claim 13, wherein the at least one computerized processor further:
provides the plurality of images to an instructor; and
receives an instructor review input of the user operating the pump panel training device including the camera device; and
wherein providing the training output to the user includes providing the instructor review input to the user.

15. The system of claim 13, wherein each of the plurality of pump panel training devices includes:
a respective plurality of gages operable to imitate gages upon a fire truck pump panel;
a respective plurality of simulated controls operable to imitate controls upon the fire truck pump panel;
a respective camera device capturing a plurality of images of a respective user operating the pump panel training device; and
a respective display device.

16. The system of claim 15, wherein the at least one computerized processor:
evaluates performances of each of the respective users;
compares the performances of the respective users; and
provides a training output based upon the comparing.

17. The system of claim 16, wherein the plurality of images of a first respective user is a plurality of images of a trainee operating a first of the plurality of pump panel training devices;
wherein the plurality of images of a second respective user is a plurality of images of an instructor operating a second of the plurality of pump panel training devices; and
wherein the at least one computerized processor providing the training output based upon the comparing includes a display output comparing the trainee operating the first of the plurality of pump panel training devices to the instructor operating the second of the plurality of pump panel training devices.

18. The system of claim 16, wherein the at least one computerized processor providing the training output based upon the comparing includes providing a side-by-side illustration of movements of the respective users or providing an illustration of the movements of a first of the respective users overlaid upon the movements of a second of the respective users.

19. The system of claim 13, wherein the at least one computerized processor further provides real-time instruction to the user.

20. A system comprising a pump panel training device and a driver training device, comprising:
the pump panel training device, including:
a plurality of gages operable to imitate gages upon a firetruck pump panel;
a plurality of controls operable to imitate controls upon the firetruck pump panel;
a camera device capturing a plurality of images of a user operating the pump panel training device;
a display device;
the driver training device operable to simulate driving operation of a fire truck; and
one or more computerized processors:
coordinating data between the pump panel training device and the driver training device;
receiving the plurality of images from the camera device; and
providing a training output to the user through the display device based upon the plurality of images.
